(19) United States
(12) Patent Application Publication
(10) Pub. No.: US 2005/0222924 A1
(43) Pub. Date: Oct. 6, 2005

(54) Insurance contract accounting system

(76) Inventors: Akira Sumino, Tokyo (JP); Hiroyuki Tasaki, Saitam (JP)

Correspondence Address: WENDEROTH, LIND & PONACK, L.L.P., 2033 K STREET N. W., SUITE 800, WASHINGTON, DC, 20006-1021, US

(21) Appl. No.: 10/513,853

(22) PCT Filed: May 9, 2003
(86) PCT No.: PCT/JP03/05842

§ 371 Date: Nov. 9, 2004

(30) Foreign Application Priority Data
May 10, 2002 (JP) 2002135943

(51) Int. Cl. G06F 17/60

(52) U.S. Cl. 705/35

(57) ABSTRACT

The present invention aims at providing an insurance contract accounting system capable of reducing waste of document papers for insurance application and eliminating labors of drawing up the necessary documents in the insurance agencies and companies (including their sales branches) while taking advantage of the conventional face-to-face sales of insurance.

An insurance contract management device 2 of the insurance company is connected to a terminal unit 3 of an insurance agent through a network 4, so that upon reception of agent authentication information from the terminal unit 3, the management device forwards to the terminal unit 3 an insurance application form for letting the agent enter insurance-related information data thereinto and receives confirming information from the terminal unit 3 upon filling in the application form, thereby to account for conclusion of the insurance contract.

### TECHNICAL FIELD

This invention relates to the technical field of a system relative to procedures for new contract or continuing contract of insurance.

### BACKGROUND OF THE ART

Insurance sales for getting an insurance contract have been hitherto conducted while providing a face-to-face explanation of a sales representative of an insurance company (insurance solicitor) to a customer. However, the insurance sales have been increasing through the spread of the Internet in recent years. Electronic commerce has the advantage that a customer can use freely at any time without feeling trouble with talking to an insurance solicitor and can ensure a beneficial result for the insurance concern to reduce the cost required for preparing various document papers such as a contract document because the necessary items for insuring can be filled in an insurance application form on a screen display. On the other hand, the benefit of face-to-face selling is that a customer can be made fully aware of articles of commerce or sufficiently take the advice of the insurance solicitor. Furthermore, the face-to-face sales for damage insurance have been often made through insurance agents or brokers hired by more than one insurance administration company, getting the convenience of offering discriminative services tailored to each insurance company. Even though the electronic commerce has been increasing with the Internet under most of these circumstances, face-to-face selling for contract of insurance has been still used at a high ratio.

The procedure for selling a customer an insurance policy by way of a face-to-face explanation will be briefly explained here, taking automobile insurance as an example. It is often the case that customers buy auto insurances through insurance agencies, but required insurance documents have been generally prepared at the representative office of the insurance agent or the home of customer's own. The sales application forms for making insurance contracts differs according to the types of insurances, i.e. new contract or renewal of a contract. If necessary, the insurance agent or broker must explain the contractual coverage of the insurance, give the customer advice and/or tentatively calculate an insurance premium. Where the customer satisfies the contractual coverage of the insurance, the customer fills in the insurance application form and signs the contract. The insurance application forms are usually made in triplicate of one duplicate copy for the customer (customer's copy), another duplicate copy for the insurance agent (agent's copy), and the original for the insurance company (original form). Then, the insurance agent submits the executed insurance application original form to the insurance company without a hitch, while reporting the insurance contract. The data on the insurance application form sent from the insurance agent are read with an OCR (optical character reader) or the like and recorded for making a booking for insurance contract in the insurance company. Correspondingly, a formal insurance policy is issued from the insurance company and sent to the insured customer or insurant by mail or other means. The insurance policy may be handed to the insurant through the insurance agent. In case of any changes in the contract such as changes in address or car, another document for proceeding with formalities for address change (acceptance form) is required. When such a document for address change is submitted in the same manner as the insurance application form noted above. The changes submitted are added to the insurance contract data controlled by the insurance company. As just described, the insurance company handles many contract documents in case of the face-to-face insurance selling.

The foregoing explanation holds an auto insurance as an example, but in any case, any insurance company deals with damage insurance, fire insurance, casualty insurance or whatever, and therefore, has to prepare various documents for applying for the insurance and making an insurance contract with customers with respect to each type of insurance. Hence, the insurance company has several problems of costing a great deal to print, distribute and store large quantity of insurance application and contract forms. Besides, when revising a law on insurance, bringing new insurance or adding a special insurance contract to the insurance system, the existing document forms become unnecessary, thus ending up in the garbage. Consequently, the conventional insurance contract system has suffered disadvantages such as a waste of printing cost, a great burden of gathering and incinerating the document forms, and adverse impacts of incinerating the document forms on the environment. Moreover, even the insurance agencies have to hold in trust many document forms such as the insurance application forms described above according to the insurance types handled by themselves. Under the circumstances, a need has been felt for an economic system capable of reducing the cost for storing the document forms.

As a means for responding to the aforesaid need, a system for improving the efficiency of insurance service by shaking down the number of necessary insurance document forms is disclosed in Japanese Patent Application Publication No. 2000-148844(A). In the system disclosed in the publication, a mobile terminal device in which a dedicated program for exclusive use is installed and a hand-held printer are handled by an insurance agent. Information data necessary for insurance policy can be input into the mobile terminal device by the sales representative of the insurance agent in accordance with the program installed in the mobile terminal device without causing trouble. The application form with the insurance contents confirmed by the customer on the screen is printed out there in the same format as is conventionally done to make out two prints, one for the customer and the other for the insurance company. The printed application forms are completed by being signeted.

The printed application form for the insurance company is sent from the insurance agent to the insurance company to report the conclusion of the contract for insurance to the insurance company. With the mobile terminal device embedded with the dedicated program and the hand-held printer, various application forms for insurance can be prepared extemporarily without preparing in advance the application forms necessary for respective types of insurances by the insurance agent (or insurance administration company).

After the steps noted above, the completed application form is printed for the insurance agent at the insurance agent office to preserve the records of the insurance contract thus concluded. In addition to the application form, an original form, which can be read by use of the OCR reader, is drawn up with the mobile terminal device for processing the insurance data independently of the completed application form or transferring the insurance data between the insurance agent and the insurance administration company via communication lines. The insurance information data have been so far processed on the basis of the completed application form, which is filled in handwriting, by use of the OCR device (optical character reader) in the insurance administration company. Although a conventional reading method has often caused inconveniences like read error or interference with office operations, increase in efficiency of data processing is attained with the aforementioned processing technology in the insurance administration company.

Thus, the processing method disclosed in Japanese Patent Application Publication No. 2000-148844(A) offers supposedly to bring solutions to the aforesaid difficulties in paperwork in the insurance agent or administration company using the mobile terminal device and hand-held printer, but yet the completed application forms prepared and signeted by the insurant have to be kept in trust at the storage facilities of the insurance agent and insurance administration company as is conventionally done, thus leaving room for improvement in wasted costs for preparing and storing the documents.

Furthermore, reporting of the concluded insurance contract from the insurance agent to the insurance administration company, which has been so far carried out using OCR document papers and through communication lines, inevitably necessitates data processing systems for preparing original form documents and submitting insurance data between the insurance agent and administration company via the communication lines, consequently making the procedures for insurance contract cumbersome and complicated.

There are few agencies which make insurance business by profession. For instance, there have been pursued many automobile distributors and detail shops as auto insurance agencies, and real estate companies as fire insurance agencies on the side. Such being the case, the insurance agencies wish to mitigate the burden of paperwork involved in insurance contract as much as possible.

In the light of the problems of the conventional insurance contract accounting systems, the present invention has an object to provide a sensible insurance contract accounting system capable of reducing waste of document papers for insurance application and eliminating labors of drawing up the necessary documents in the insurance agencies and companies (including their sales branches).

### DISCLOSURE OF INVENTION

To attain the object described above according to the present invention, there is provided an insurance contract accounting system comprising the following means.

That is, the system of the invention comprises an insurance contract accounting system comprising an insurance contract management device connected to a terminal unit of an agent and the like through a network, which management device includes an agent authentication assist means for transmitting a form for letting the sales representative enter the agent authentication information data assigned to the agent by an insurance company, application form drafting means for drawing up an application form for insurance on the basis of the application data sent from the terminal unit, application form transmission means for transmitting the drawn application form to the terminal unit to display the form on the terminal unit, and a contract conclusion means for concluding the insurance contract upon reception of confirmation data indicative of closing of the insurance application from the terminal unit.

Further, the invention provides an insurance contract accounting system comprising an insurance contract management device connected to a terminal unit of an agent and the like through a network, which management device includes an agent authentication assist means for transmitting a form for letting the sales representative enter the agent authentication information data assigned to the agent by an insurance company, an authentication means for authenticating information data sent from the terminal unit of the agent, an application assist means for transmitting a form for letting the sales representative enter the application data for an insurance contract and insurance related information data to the terminal unit having information data authenticated, application form drafting means for drawing up an application form for insurance on the basis of the application data sent from the terminal unit, application form transmission means for transmitting the drawn application form to the terminal unit to display the form on the terminal unit, a contract conclusion means for concluding the insurance contract upon reception of confirmation data indicative of closing of the insurance application from the terminal unit, and contract accounting means for accounting the insurance contract stipulated on the completed application form at the time of closing of the procedure of the insurance contract.

According to the aforementioned insurance contract accounting systems of the invention, the insurance application is achieved by acquiring and attesting the agent authentication information sent from the terminal unit to the insurance contract management device and transmitting only to the terminal unit of the agent the form for letting the sales representative enter the agent authentication information data assigned to the agent by an insurance company. The application form can be displayed on the terminal unit of the agent to be shown to the agent and/or the customer. While receiving and confirming the application information sent from the terminal unit of the agent, the insurance company can check up the contents of the application and be aware of the customer's intention of conclusion of the contract. Upon completion of the contract, the insurance contract prescribed in the completed application form is recorded at the insurance company. The agent herein serves to sell various consignments of insurance goods commissioned by the insurance company on behalf of the insurance company (including invitation to insure and arrangement of conclusion of an insurance contract). In a case that the agent is not mediated between the insurance company and the customer or insurance policy purchaser, an insurance canvassing solicitor or a sales representative of the insurance company is equivalent to the agent. The customer herein is an insurance policy purchaser who is sometimes referred to as an insurant after the insurance contract is concluded.

The aforementioned contract accounting means may be operated in conjunction with the terminal units by commands exchanged between the contract accounting means and the terminal unit.

The confirmation data received on the contract conclusion means, which contains specific information of the customer, are transmitted to the terminal unit of the agent, so that even a conventional application form can be used to be signed and executed.

The insurance contract accounting system may further comprises confirmation drawing means for drawing a contract confirmation document containing the confirmation matters of conclusion of the insurance contract for the customer so as to deliver the contract confirmation document drawn at the time of concluding the insurance contract to the customer, so that, even if causing any trouble such as an iniquitous insurance contract without the customer knowing, such irregularities can be found instantaneously. The delivering of the contract confirmation document may be carried out via the Internet or by postal mail.

The insurance contract management device may be provided with an agent authentication information acquisition means for obtaining terminal authentication information for identifying a specific terminal unit, so as to make it possible to specify which terminal unit is connected to the insurance contract management device.

Since the authentication means serves to determine an authentication level from a combination of the agent authentication information and the terminal authentication information, the authentication level of one who is connected to the insurance contract management device can be determined on the basis of the agent authentication information and the terminal authentication information.

The insurance contract management device may be provided with a service information means for allowing information of service which the insurance company can provide to be sent to the terminal unit, so that the contents of available service sent from the insurance contract management device to the terminal unit can be changed in accordance with the authentication level. Consequently, security level can be changed with the authentication level.

Since the customer can enjoy the services associated with the concluded contract upon authenticating the agent authentication information and the terminal authentication information by the authentication means, procedures for entering into the insurance contract with the customer can be carried forward when the agent authentication information indicating a person responsible of the insurance agent and the terminal authentication information indicating what terminal unit is connected to the insurance contract management device are authenticated.

Since the services associated with the concluded insurance can be browsed on the authentication means upon authenticating the agent authentication information and the terminal authentication information by the authentication means, information related to the concluded insurance can be browsed with the terminal unit when authenticating the agent authentication information indicating a person responsible of the insurance agent.

### BRIEF DESCRIPTION OF THE DRAWINGS

FIG. 1 is a block diagram showing a first embodiment (1) of an insurance contract accounting system.

FIG. 2 is a detailed block diagram showing the first embodiment (1) of the insurance contract accounting system.

FIG. 3 is a detailed block diagram showing the first embodiment (1) of the insurance contract accounting system.

FIG. 4 is a flow chart showing the operating of the first embodiment (1) of the insurance contract accounting system.

FIG. 5 is the flow chart showing the operating of the first embodiment (1) of the insurance contract accounting system.

FIG. 6 illustrates a screen-displayed example on a terminal unit of the insurance contract accounting system in the first embodiment (1).

FIG. 7 illustrates the screen-displayed example on the terminal unit of the insurance contract accounting system in the first embodiment (1).

FIG. 8 illustrates the screen-displayed example on the terminal unit of the insurance contract accounting system in the first embodiment (1).

FIG. 9 illustrates the screen-displayed example on the terminal unit of the insurance contract accounting system in the first embodiment (1).

FIG. 10 illustrates the screen-displayed example on the terminal unit of the insurance contract accounting system in the first embodiment (1).

FIG. 11 illustrates the screen-displayed example on the terminal unit of the insurance contract accounting system in the first embodiment (1).

FIG. 12 illustrates the screen-displayed example on the terminal unit of the insurance contract accounting system in the first embodiment (1).

FIG. 13 illustrates the screen-displayed example on the terminal unit of the insurance contract accounting system in the first embodiment (1).

FIG. 14 illustrates the screen-displayed example on the terminal unit of the insurance contract accounting system in the first embodiment (1).

FIG. 15 illustrates the screen-displayed example on the terminal unit of the insurance contract accounting system in the first embodiment (1).

FIG. 16 illustrates the screen-displayed example on the terminal unit of the insurance contract accounting system in the first embodiment (1).

FIG. 17 illustrates the screen-displayed example on the terminal unit of the insurance contract accounting system in the first embodiment (1).

FIG. 18 illustrates the screen-displayed example on the terminal unit of the insurance contract accounting system in the first embodiment (1).

FIG. 19 illustrates the screen-displayed example on the terminal unit of the insurance contract accounting system in the first embodiment (1).

FIG. 20 illustrates the screen-displayed example on the terminal unit of the insurance contract accounting system in the first embodiment (1).

FIG. 21 is the flow chart showing the operating of the first embodiment (1) of the insurance contract accounting system.

### BEST MODE FOR CARRYING OUT THE INVENTION

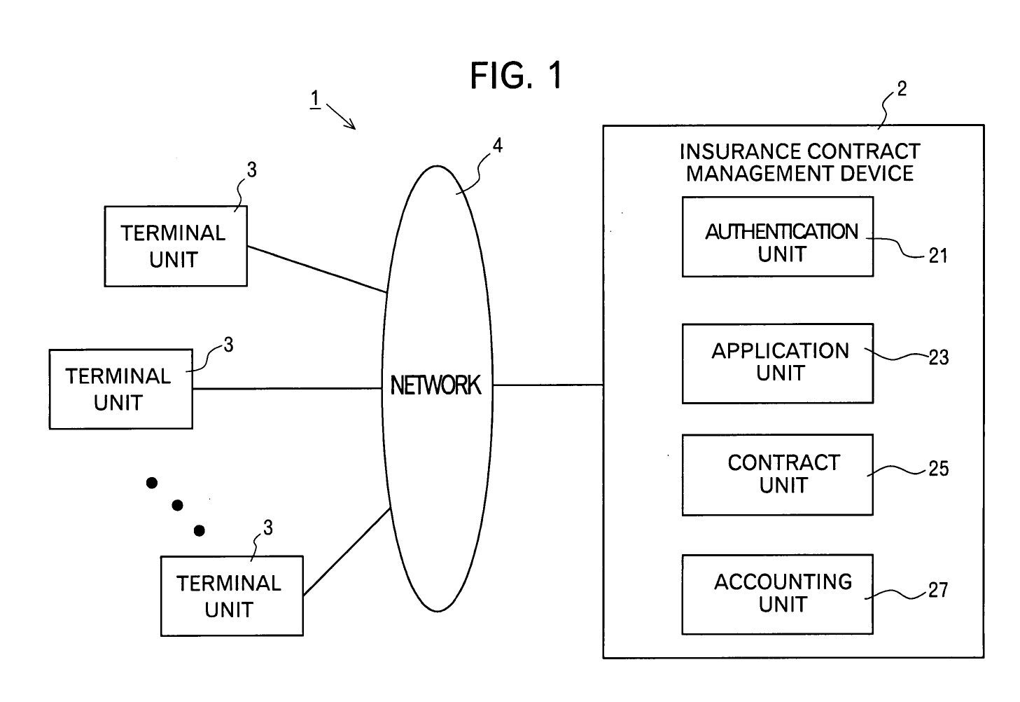

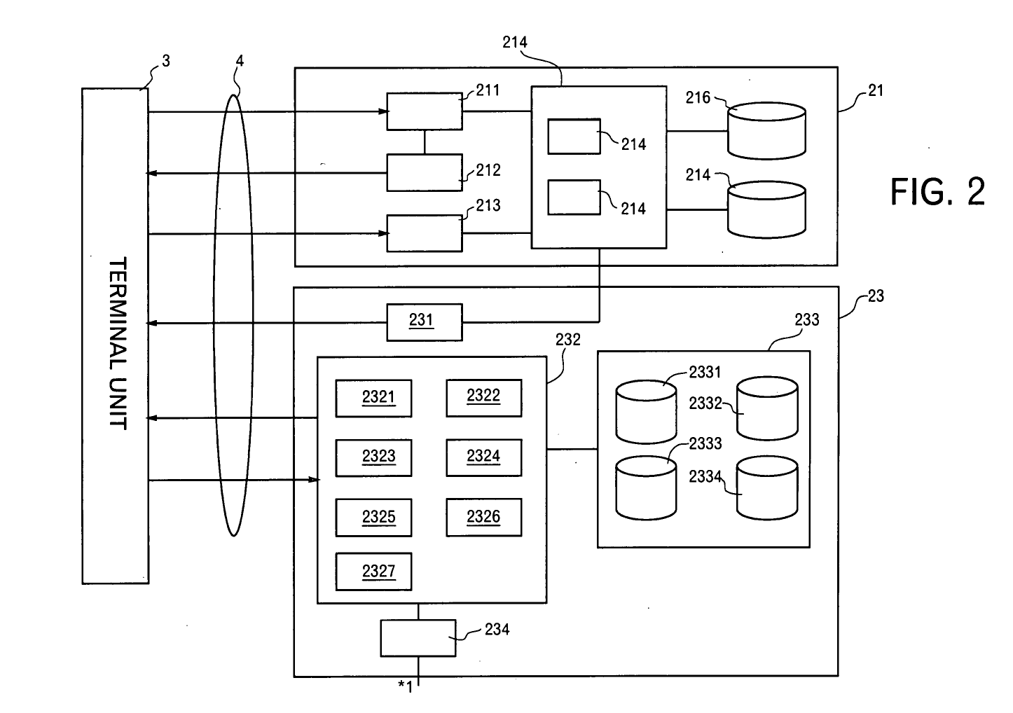

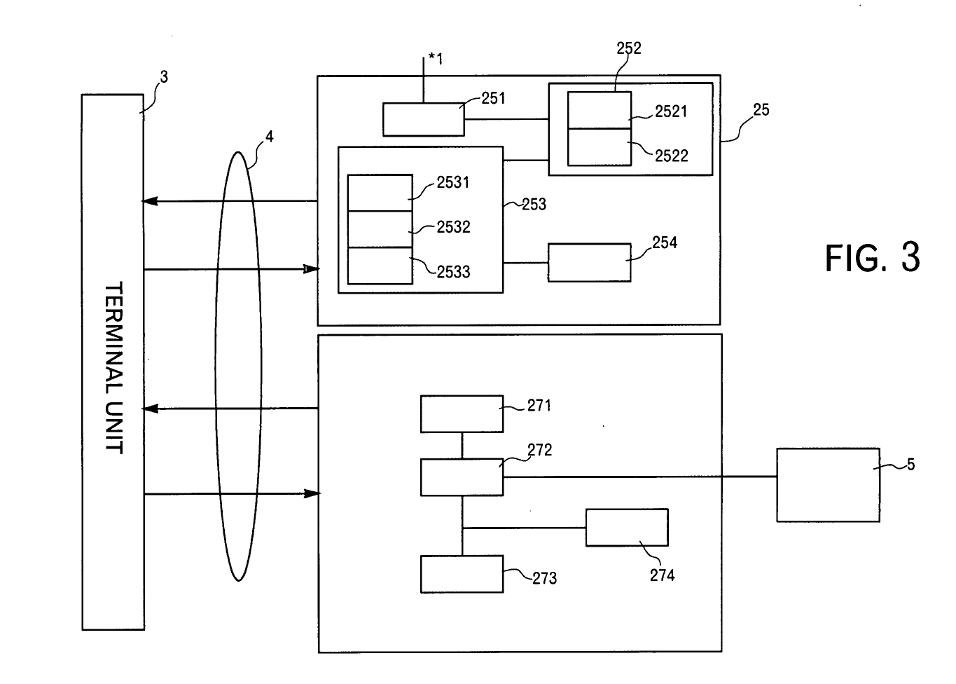

One preferred embodiment of the insurance contract accounting system according to the present invention will be described hereinafter with reference to the accompanying drawings. FIG. 1 is a block diagram showing a first embodiment (1) of an insurance contract accounting system, and FIGS. 2 and 3 are detailed block diagrams showing the first embodiment (1) of the insurance contract accounting system. FIGS. 2 and 3 continue to each other at the point “*1” in the drawings.

The insurance contract accounting system 1 in the embodiment (1) of the invention comprises an insurance contract management device 2 and a terminal unit 3, which are connected to each other through a network 4.

An aspect in which the system of the invention is applied to services of auto insurance, which is one of damage insurances, will be described herein by way of example, but this invention may be applied to any other life and nonlife insurance service business including fire insurance and accident insurance.

The insurance contract management device 2 essentially has an input and output function, recording function, communication function, calculation function and so on. It may be formed of a mainframe computer, work-station computer or personal computer operable in collaboration with other computers as a general manner. Alternatively, the insurance contract management device 2 may of course be composed from a combination of a plurality of servers and terminal units or devices, and connected to external database systems according to need. The insurance contract management device 2 is installed in an insurance company and connected to a host computer of the insurance company.

The terminal unit 3 essentially has an input and output function, recording function, communication function, display function and so on. It is provided with a button means, touch panel, key board and/or mouse for fulfilling the input and output function. For the display function (display screen), there may be used LCD, CRT or the like. The terminal unit may be a personal computer, handheld mobile terminal (personal digital assistant; PDA), cell phone, fixed-line phone, household appliance (television, refrigerator, etc.), car navigation system, game console and so forth. The terminal unit 3 is used at the option of a user, sales representative of an insurance agent, that is, there may be used a terminal device installed in an insurance shop, a private personal computer owned by the sales representative of the insurance agent or the customer, or a terminal unit equipped at an Internet cafe or a hotel.

The network 4 includes a communication system for Internet or other communication means.

Next, the formation of the insurance contract management device 2 will be explained here. The insurance contract management device 2 comprises an authentication unit 21 for authenticating an insurance customer, an application unit 23 for dealing with the procedure of making an insurance application, a contract unit 25 for dealing with the procedure of making an insurance contract, and an accounting unit 27 for accounting the insurance contract.

The authentication unit 21 includes a terminal authentication information acquisition means 211 for obtaining a terminal authentication information for identifying the terminal unit 3, an agent authentication assist means 212 for transmitting a form for letting the sales representative enter the agent authentication information data assigned to the agent by an insurance company to the terminal unit 3, an agent authentication information acquisition means 213 for authenticating information data sent from the terminal unit of the agent in accordance with the agent authentication information form, and an authentication means 214 for authenticating the agent authentication information and the terminal authentication information in combination. There are further provided a terminal authentication information database unit 216, which pre-stores the terminal authentication information of the terminal unit 3 allowed to be connected to the insurance contract management device 2, and an agent authentication information database unit 217, which pre-stores the agent authentication information assigned to the insurance agent allowed to be connected to the insurance contract management device 2. These database units may be connected to external database systems.

The terminal authentication information obtained by the terminal authentication information acquisition means 211 serves to identify which terminal unit is connected to the insurance contract management device 2 and is provided for being automatically outputted when the predetermined terminal unit 3 is connected to the insurance contract management device 2. Although the terminal unit 3 can be connected to the insurance contract management device 2 even if the insurance contract management device does not acquire the terminal authentication information, an authentication level prescribed in an authentication means 21 is influenced as will hereinafter be described in detail. The predetermined terminal unit 3 may be terminal device installed in an insurance shop, or a private personal computer owned by the sales representative of the insurance agent or the customer. In a case that the terminal unit 3 is a desktop computer or a handheld mobile terminal (personal digital assistant; PDA), the terminal authentication information is installed in advance on the terminal unit, so that authentication between the terminal unit 3 and the insurance contract management device 2 can be conducted at the time of making dialup connections by submitting the terminal authentication information to the insurance contract management device (i.e. client authentication) or identifying the handwritten signature (fingerprint, iris and so on) of a sales representative of the insurance agent (biometrics authentication). The latter method enables simultaneous authentication at the terminal unit 3 and the insurance contract management device 2. In a case where a cellphone is used for the terminal unit 3, a dedicated adapter is required to be plugged into the cellphone for making an Internet connection. By plugging the adapter into the cellphone, the terminal unit is automatically connected to the insurance contract management device 2, simultaneously to submit the terminal authentication information stored in the adapter to the insurance contract management device 2. In this case, when the sales representative of the insurance agent plugs the dedicated adapter into such a given portable terminal, the terminal authentication information can be submitted to the insurance contract management device. The dedicated adapter should be possessed and managed only by the sales representative or an insurance solicitor accepted by the insurance company. In principle, one insurance agent is permitted to possess one dedicated adapter, but the insurance agent employing more than one insurance solicitor (sales representative) may be permitted to have more than one dedicated adapter.

The agent authentication assist means 212 calls on the user of the terminal unit 3 to enter the agent authentication information data. The agent authentication information is provided for identifying who is connected to the insurance contract management device 2 and contains specific codes such as user ID and password given by the insurance company. Further higher technology using one-time password may be applied. The agent authentication information is assigned per agent in principle, but more than one agent authentication information may be given to the insurance agent employing more than one insurance solicitor (sales representative). In most cases, specialized professional insurance agents, car maintenance shops, car dealers including used car dealerships, and other business agents act as the representatives (channels) of the insurance companies to offer insurance services. Thus, the agent authentication information given by the insurance company may contain information for identifying each insurance representative.

In the terminal authentication information database 216, the terminal authentication information is previously stored in correlation with the agent information (name, insurance type, contact detail of the agent) of the insurance agent assigned with the terminal authentication information, and the authentication method (client authentication, biometrics authentication, etc.).

The authentication means 214 includes a verification means 2141 for varying each of authentication information data, and a level determination means 2142 for determining an authentication level depending on the condition of authentication. In the case of assigning the terminal authentication information and the agent authentication information to the insurance agent, confirmation on whether the terminal or agent authentication information coincides with the data previously stored in the terminal authentication database 216 or agent authentication database 217 is made. The level determination means will be described later.

Next the application unit 23 will be described. The application unit 23 is provided with a service information means 231 for giving the terminal unit 3 information of services provided from the insurance contract accounting system 2 of the insurance company, an application assist means 232 for transmitting a form for letting the sales representative enter the application information for the insurance contract and insurance-related information, an insurance related information database 233 for assisting the filling-in of the application data necessary for the insurance contract, and an application form drafting means 234 for making up the application form based on the application data submitted from the terminal unit 3. The insurance related information database 233 is composed of a plurality of databases, which may be disposed outside the insurance contract management device 2.

From the service information means 231, information of services provided by the insurance company is transmitted from the insurance contract management device 2 to the terminal unit 3, so as to display the contents of the services on the terminal unit 3 in the form of a menu 2311. Determination on whether the customer can enjoy one of the services informed by the service information means 231 is made by the result of assertion according to the level determination means 2142.

The level determination means 2142 serves to determine the level of authentication verified by the verification means according to whether the authentication information confirmed by the verification means 2141 contains one or both of the terminal authentication information and the agent authentication information. Acquisition of the terminal authentication information means that the terminal unit permitted to be connected is in use in the case where the sales representative of the insurance agent connects a computer installed at the insurance agent shop or his/her handheld mobile terminal (personal digital assistant; PDA) to the insurance contract management device 2 by using the technical way of client authentication or biometrics authentication, or in the case where the sales representative of the insurance agent connects his/her terminal means by use of the dedicated adapted plugged into his/her cellphone to the insurance contract management device 2. Acquisition of the insurance agent authentication information means that the user or customer permitted to connect uses the terminal unit upon entering the customer's ID code or password previously given by the insurance company to submit the customer's personal information to the insurance contract management device 2. There are four level situations: the first situation in which both the terminal authentication information and the agent authentication information are acquired at the insurance contract management device 2 (Level 1), the second situation in which only the agent authentication information is acquired (Level 2), the third situation in which the terminal authentication information is acquired (Level 3), and the fourth situation in which no authentication information is acquired (Level 4). The situation of Level 1 includes a case example in which the authenticated user (sales representative of the insurance agent) uses the authenticated terminal unit 3 to have the highest authentication level. The situation of Level 2 includes a case example in which the authenticated user uses an unauthenticated terminal unit 3 (e.g. a terminal computer of a customer, a computer available at an Internet cafe or other public computer). The situation of Level 3 includes a case example in which the authenticated terminal unit 3 is used by an unauthenticated user to fall on a lower authentication level. The fourth situation of Level 4 includes a case example in the unauthenticated user use the unauthenticated terminal unit to fall on the lowest authentication level.

There are various services notified to the terminal unit 3 by the service information means 231. The services provided by the insurance company includes, for instance, advice about continuing contract of auto insurance, new contract of auto insurance and insurance contract accounting, application of changes, enquiry on insurance contract, management information of soliciting performance and unsealed continuing contract, explanatory information of insurance goods, insurance policy and general contractual conditions, general information from the insurance company, domicile and phone book (insured list), estimated insurance premiums, settlement of the insurance premiums (credit-card authorization), enquiry of record information of accidents, procedure of notification of accidents, procedure of insurance claim, and so forth. The services provided by the insurance company are categorized, given respective item names and indicated in the menu 2311 on the terminal unit 3. The menu 2311 may be formed in a hierarchical service menu. The services are enumerated here by way of examples and should not be understood as being limited thereto.

Of these services provided by the insurance company, the services concerning the concluded insurance contract (e.g. continuing contract of auto insurance, new contract of auto insurance and insurance contract accounting, application of changes, procedure of notification of accidents, and procedure of insurance claim) are a matter of great importance in payment of insurance, and therefore, graded on Level 1 or Level 2. These significant services are not available to Level 3 and Level 4.

In the menu 2311 indicative of the services notified to the terminal unit 3, only the services may be indicated in accordance of the authentication level, or expressed in the manner of a hierarchical menu so that the services provided by the insurance company are merely displayed, but requires authentication at the prescribed level or higher if leveraged. Although both the terminal authentication information and the agent authentication information are required in this embodiment, one or three or more authentication information may suffice for authentication.

The application assist means 232 assists in deciding and filling in the necessary items for insurance contract on the insurance contract application form in sequence when the insurance contract service is chosen for the menu 2311 on the display of the terminal unit 3. There are two types of insurance contract services, i.e. new contract and continuing contract, involving somewhat different procedures. Thus, the application assist means 232 provides a plurality of insurance contract application procedures with application forms to be transmitted to the terminal unit 3, so that a combination and order of the procedures specified from the terminal unit 3 can be aptly changed according to communications between the terminal unit and the insurance contract management device. The application assist means 232 includes a vehicle information assist means 2321 for transmitting a vehicle information entry form 23211 for facilitating data input of vehicle information (vehicle type, car registry number, vehicle name, type number, initial registration date, etc.), an insurant information assist means 2322 for transmitting the vehicle information entry form 23211 for facilitating data input of insurant information (name, phonetic name, postal zip code, domicile, phone number, e-mail address, etc.), a recommended insurance advice means 2323 for transmitting information of insurance contract recommended to the customer or insurant selected according to the vehicle information, and a trial-calculation representation means 2324 for representing a trial-calculation result 23241 of insurance premium estimated according to the contract desired by the customer or insurant. In addition, there is provided an expiration information transmission means 2325 for notifying contract expiration information of the contracted insurance (expiration list or the like) of the insurant (customer already insured) to which the sales representative of the insurance agent provides support, an expiration notice transmission means 2326 for transmitting notice of insurance expiration information 23261, which was already mailed to the insurant prior to the expiration date of an insurance policy, and an insurant information transmission means 2327 for displaying insurant information (name, phonetic name, postal zip code, domicile, phone number, e-mail address, etc.)

The insurance related information database 233 is provided with an insurance policy database 2331 storing an insurance policy in correlation with the vehicle information, a premium trial-calculation database 2332 for tentatively calculating the insurance premium in accordance with the insurance contract, an expiration information database 2333 storing expiration information such as the insurance agent having charge of the insurant whose insurance policy is expiring, expiration date, recommended insurance plan and other information, and an insurant database 2334 storing the insurance information of the insurant (name, phonetic name, postal zip code, domicile, phone number, e-mail address, etc.), in order to subserve the operation of each means disposed on the application assist means 232.

The application form drafting means 234 is provided for making up an application form 2341 upon receiving the vehicle information inputted on and submitted from the terminal unit 3 by using the application assist means 232, and the application data including the insurant information and the insurance policy selectively or optionally concluded, and other information data.

The application assist means 232 and the insurance related information database 233 should not be limited to the foregoing and may be modified or adjusted in number according to the procedures of preparing the application form and the services prescribed by the insurance contract management device 2. As the need arises, image data of a driver's license and/or a vehicle inspection certificate or electronic data of license information stored in an IC memory may be submitted from the terminal unit 3 to the insurance contract management device 2.

In a case where other service than the contracted services is chosen on the service information means 231 by way of example, the application assist means 232 may be operated to consult the insurance related information, so as to permit the information stored in the insurance related information database 233 to be transmitted to and displayed on the display screen of the terminal unit 3. When selecting the trial calculation of the insurance premium from the menu, one or more forms for assisting filling-in of the necessary data (vehicle information and/or desired contract policy) for tentatively calculating the insurance premium are first transmitted to the terminal unit 3, and then, the premium trial-calculation database 2332 is searched, thus to retrieve the result of trial calculation to the terminal unit. In selecting the insurance goods provided by the insurance company, insurance policy or contractual conditions from the menu, the required information is retrieved from the database (not shown) storing the insurance goods provided by the insurance company, insurance policy or contractual conditions to the terminal unit 3.

Next, the contract unit 25 will be described. The contract unit 25 is provided with an application form transmission means 251 for transmitting the application form 2341 drawn up on the basis of the application information to the terminal unit 3, a contract conclusion means 252 for completing the insurance contract upon receiving confirming information indicative of confirmation of the application form from the terminal unit 3, a payment means 253 for arranging for insurance payment, and a contract completion notification means 254 for notifying completion of the insurance contract to the terminal unit 3.

The application form transmission means 251 serves to transmit the application form 2341 drawn up by the application form drafting means 234 to the terminal unit 3 to display the form on the terminal unit. The complete data required for the insurance contract, which are the same as those filled in a conventional application form are displayed on the display screen of the terminal unit.

The contract conclusion means 252 is provided with a confirmation assist means 2521 for transmitting to the terminal unit 3 a confirming information entry form 2521 for assisting the filling-in of the confirming information data, and a confirming information detection means 2522 for detecting whether or not the confirming information is submitted from the terminal unit 3. The confirming information is dedicated for determining that the contents of the application form 2341 is confirmed by the insurant by use of the insurance contract management device 2, correspondingly to a written contract under seal. Since the sales representative should give an explanation of the important details of the insurance policy in confirming the application data, the confirming information semantically implies that the insurant has been made aware of the insurance policy. The important details explained to the insurant contains obligation of representation and notification, insurance coverage, roles of the insurance agent, general contractual conditions and so forth. The confirming information should preferably be an insurant's own or specific information such as date of the insurant's birth, which the sales representative of the insurance agent does not know, in order to prevent impropriety. It is desirable for the insurant to block views of others including the sales representative of the insurance agent when entering the confirming information. The confirming information must be known only by the insurant, and therefore, may be the number of the health insurance card or public number of the insurant if any.

The payment means 253 is provided for carrying out the procedure for insurance payment upon submitting a form for applying payment of insurance benefit and filling in the necessary information. The payment means 253 is provided with a payment selection means 2531 for allowing the insurant to select a method of insurance payment, payment information assist means 2532 for assisting the fling-in of the data necessary for payment of the insurance benefit, and a payment information reception means 2532 for receiving the payment information. The payment selection means 2531 transmits a payment selection form 25311 for allowing the insurant to select the method of the insurance payment from a variety of insurance payment methods (cash payment, credit card, direct debit and net debit transactions, convenience banking payment, cellphone's payment, etc.) The payment information assist means 2532 further functions to transmit a payment information entry form 25321 for filling in the insurance payment information to the terminal unit 3 in accordance with the payment method selected by the insurant. The insurance payment information contains the credit card number, expiration date of the credit card and other personal information in the case of the credit card or net debit transactions, the account number, account holder's name and other personal information in the case of the account transfer payment, and information such as the name of the appointed convenience banking and e-mail address to which a store reception number is sent in the convenience banking payment. For the cellphone's payment, credit card data saved in an IC chip in the cellphone of the customer are used.

The contract completion notification means 254 serves to transmit to the terminal unit 3 a contract completion notice 2541 upon completion of the payment procedure in the payment means 253 after detecting the confirming information by the confirming information detection means 2522 and then display the contract completion notice on the terminal unit. Thus, the sales representative of the insurance agent and the customer can recognize the conclusion of the insurance contract.

Next, the accounting unit 27 will be described. The accounting unit 27 is provided with an accounting assist means 271 for transmitting to the terminal unit 3 an accounting instruction form 2711 for giving accounting instructions to record accounting of the concluded insurance contract, an insurance accounting means 272 for accounting the concluded insurance contract to the insurance company in accordance with the accounting instruction information received from the terminal unit 3, a completed accounting notification means 273 for transmitting to the terminal unit 3 a completed accounting notice 2731 of the completed accounting of the insurance contract, and confirmation drawing means 274 for making up a concluded contract confirmation to be given to the customer.

The accounting instruction information is entered into the terminal unit 3 referring to the accounting instruction form 2411 given from the accounting assist means 271. The accounting instruction information is provided for reporting the contents of the concluded insurance contract to the insurance company and conclusively confirming the agent's decision accounting for the concluded insurance contract. Only by selecting the item “booking” on the display of the terminal unit 3, the agent's decision can be submitted.

The contents of the concluded insurance policy fulfilled in the contract unit 25 is recorded by using the insurance accounting means 272 in accordance with the accounting instructions sent from the terminal unit 3. The booking of the concluded insurance contract is registered in database on the insurance policy in the host computer of the insurance company. This online data processing method is alternative to a conventional procedure using a system for sending the necessary documents by postal mail or facsimile and reading the data on the documents using an OCR device. The insurance accounting means 272 serves to enter into the host computer 5 the contents on the application form 2341 drawn up in the interactional sequences described above using the insurance contract management device 2 without modification. Although the concluded insurance policy is booked with direction by the terminal unit 3 in this embodiment (1), it may be booked without direction by the terminal unit 3 at the time of concluding the insurance contract.

The completed accounting notification 2731 is displayed on the display of the terminal unit 3 by the completed accounting notification means 273 to make the booking of the concluded insurance contract known to the sales representative of the insurance agent.

With the confirmation drawing means 274, a written contract confirmation to be sent to the insured customer or insurant by postal mail is made up. The contract documents are sent from the insurance company directly to the insurant by postal mail along with the insurance policy, so that even unauthorized or fraudulent contract can be learnt and signed off from the reaction or feedback from the customer. Although the written contract confirmation is sent to the customer in this embodiment by postal mail, it may be sent to the customer's e-mail address by e-mail.

As will be appreciated from the foregoing, the terminal unit 3 is an optional element basically having functions of receiving the information from the insurance contract management device 2, displaying the information to permit the user to enter required data referring to various instruction forms, and submitting the entered information to the insurance contract management device 2.

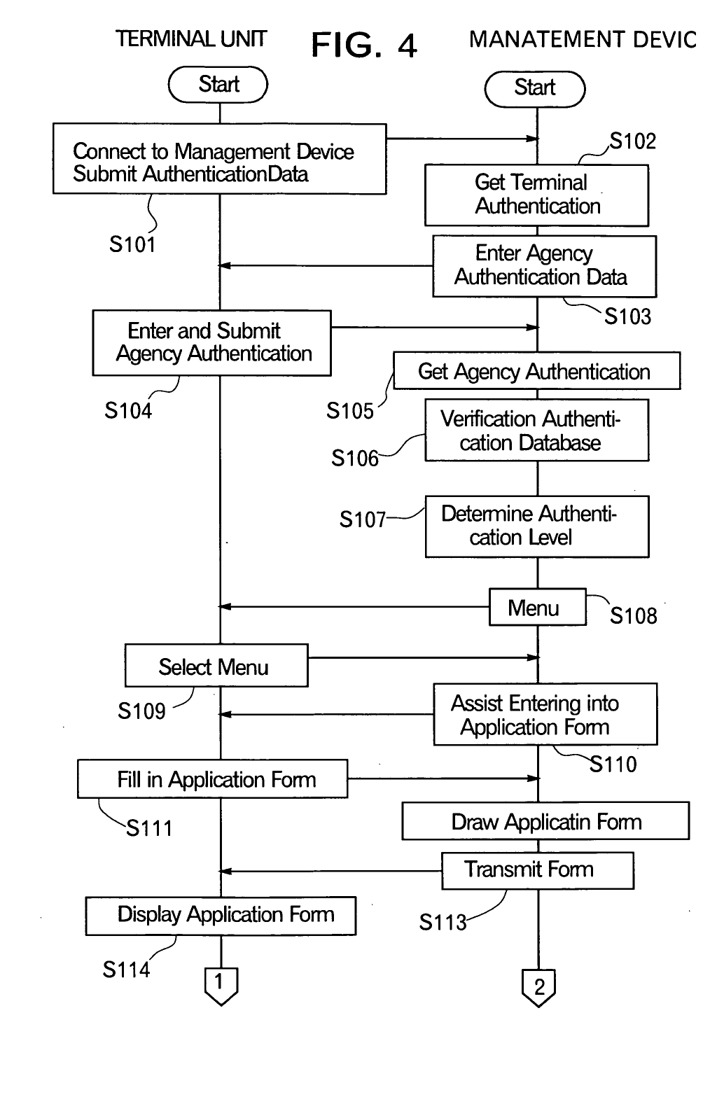

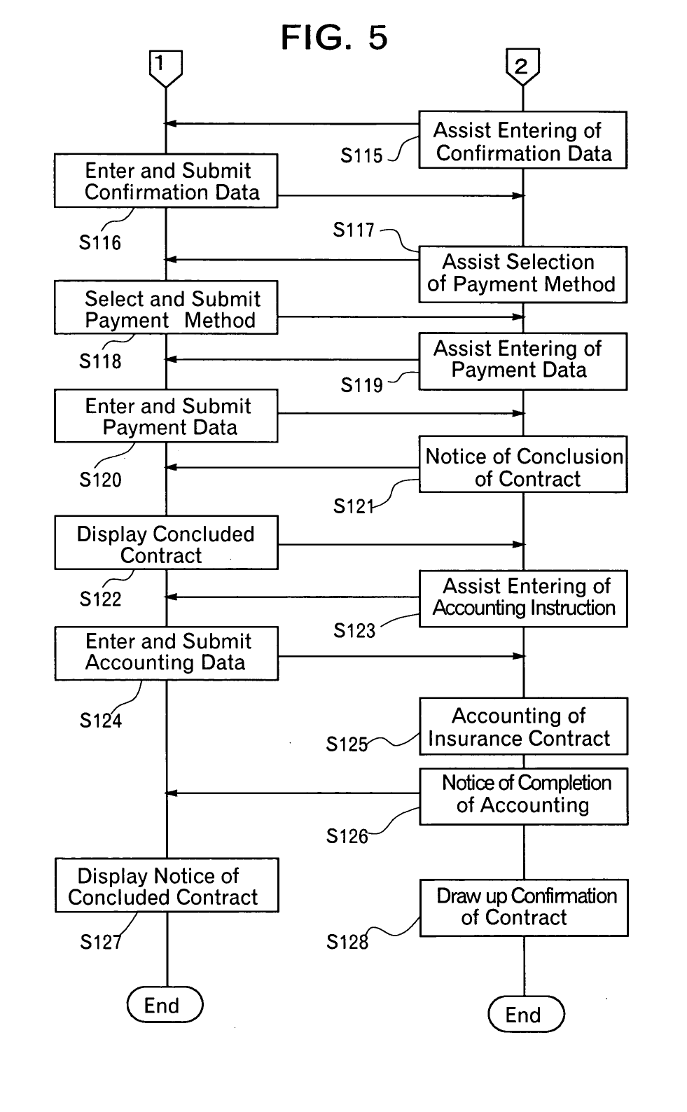

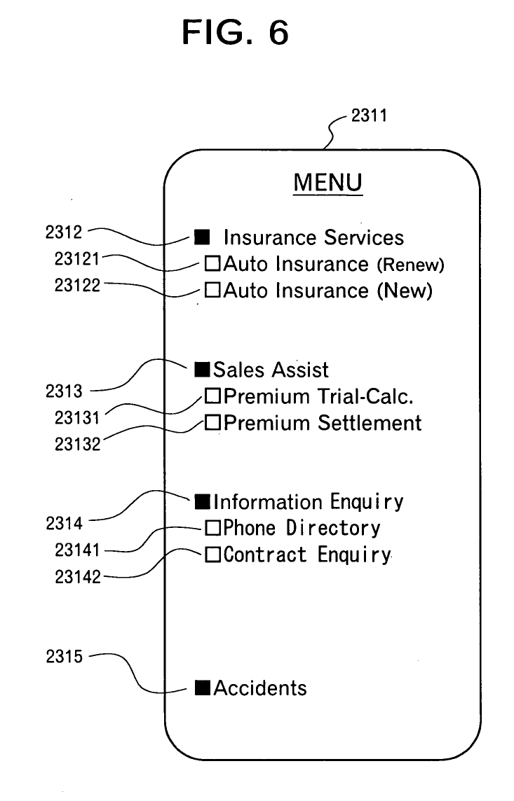

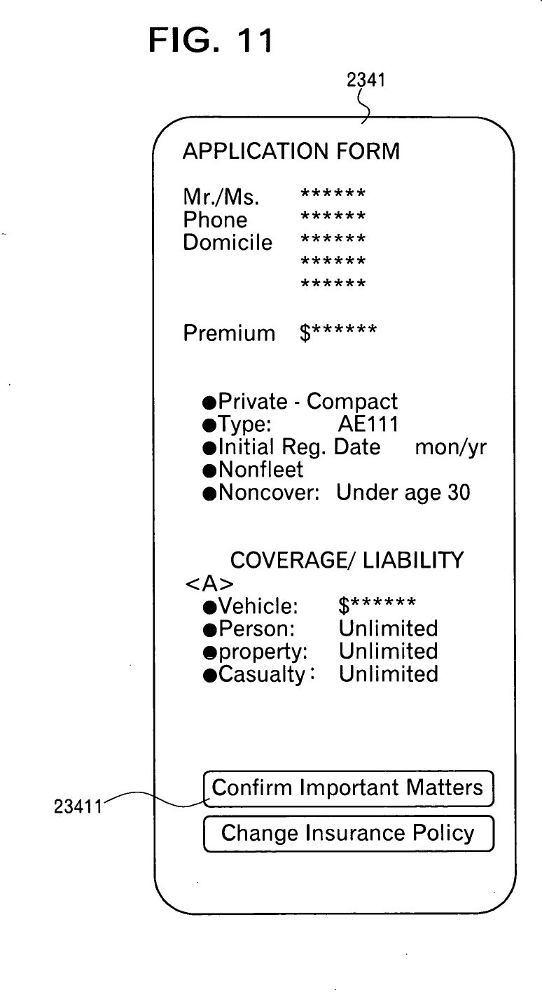

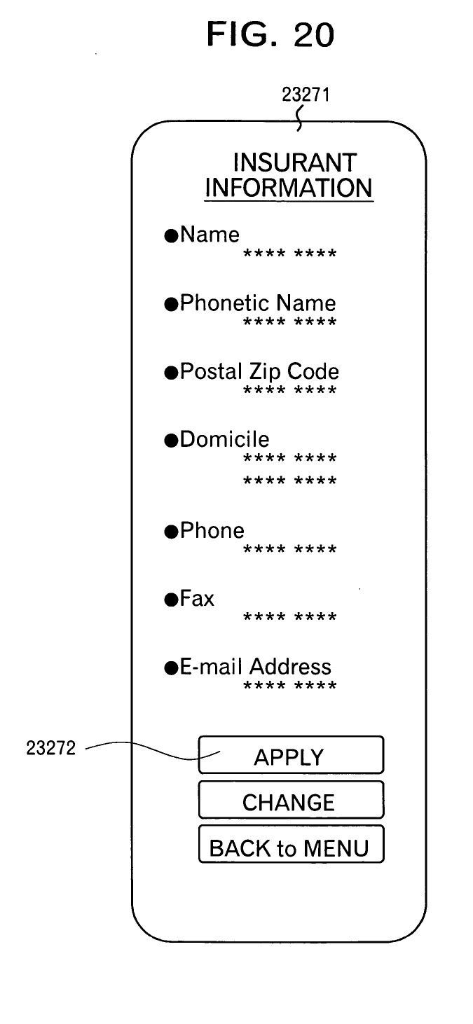

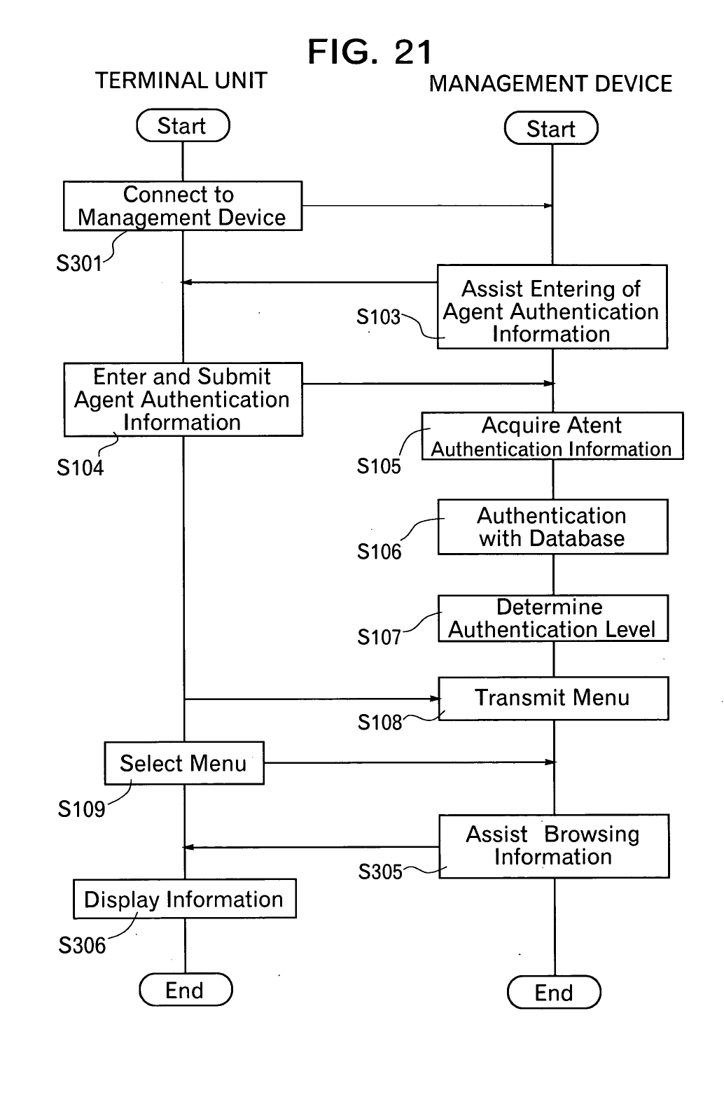

The insurance contract accounting system 1 in the first embodiment (1) will be explained in concrete terms with reference to FIG. 4 through FIG. 20. FIGS. 4 and 5 are flow charts showing the operating of the first and second working examples in the embodiment (1) of the insurance contract accounting system. FIGS. 6 and 20 are the screen-displayed examples on the display of the terminal unit of the insurance contract accounting system in the embodiment (1). FIG. 21 is the flow chart showing the operating of the third working example of the insurance contract accounting system in the embodiment (1).

### WORKING EXAMPLE 1

There will be described herein the first working example 1 in which the system in this working example 1 is applied for placing new insurance contract while the insurance contract management device 2 receives both the terminal authentication information and the agent authentication information.

First, the sales representative of the insurance agent handles a specific terminal unit 3 to be connected to an insurance contract management device 2 via a network 4 in conducting insurance service negotiation (S101). The insurance service requires the highest authentication level “Level 1”. The sales representative of the insurance agent inserts a dedicated adapter into a cellphone to automatically connect the terminal unit to the insurance contract management device 2 via the Internet.

When the terminal authentication information is submitted from the terminal unit 3 to the insurance contract management device, the insurance contract management device 2 receives the terminal authentication information at the terminal authentication information acquisition means 211 (S102), and then, transmits an agent confirming information entry form to the terminal unit 3 by using the agent authentication assist means 212 (S103). On the terminal unit 3 which receives the agent confirming information entry form, an instruction image for letting the sales representative enter a given ID code and password. The sales representative of the insurance agent or insurance solicitor enters the ID code and password previously given to the insurance agent into the terminal unit, so that the ID code and password are submitted to the insurance contract management device 2 (S104) and inputted into the agent authentication information acquisition means 213 (S105). Regardless of whether the terminal authentication information is submitted, the agent authentication information entry form is transmitted from the agent authentication assist means 212 to the relevant terminal unit 3. However, since the contract service is performed at the highest authentication level, it is required to make the terminal unit 3 responsive to the prescribed authentication level so as to get the sales representative to submit both the prescribed terminal authentication information and agent authentication information to the insurance contract management device. Subsequently, to authenticate the user of the terminal unit 3 with the authentication means 214, the terminal authentication information and the agent authentication information are verified with the terminal authentication information database 216 and agent authentication information database 217 by using the verification means 2141(S106). Then, the authentication level of the terminal unit 3 attempting to be connected to the insurance contract management device is determined in accordance with a combination of the terminal authentication information and agent authentication information by using the level determination means 2142 (S107). The authentication level in this situation is the highest since both the terminal authentication information and agent authentication information are received.

Next, the services contributing to the terminal unit 3 is notified in the form of a menu to the terminal unit through the service information means 231 in accordance with the result of determination of the authentication level obtained by the level determination means 2142 (S108). Since the authentication level in this case is determined as the highest level, all the available services are displayed on the display of the terminal unit 3, so that the customer can select whichever service the customer wants. The example of the representation of the displayed menu 2311 is shown in FIG. 6. The menu 2311 contains the major items “Contract Services” 2312, “Sales Assist” 2313, “Enquiry” 2314, and “Accident” 2315, and the minor items “Auto Insurance (renewal)” 23121, “Auto Insurance (new)” 23122, “Trial Calculation” 23131, “Settlement” 23132, “Phone Directory” 23141, and “Contract Enquiry” 23142. As an example, the item “Auto Insurance (new)” 23122 is selected to pursue new insurance contract and notified to the insurance contract management device 2 (S109).

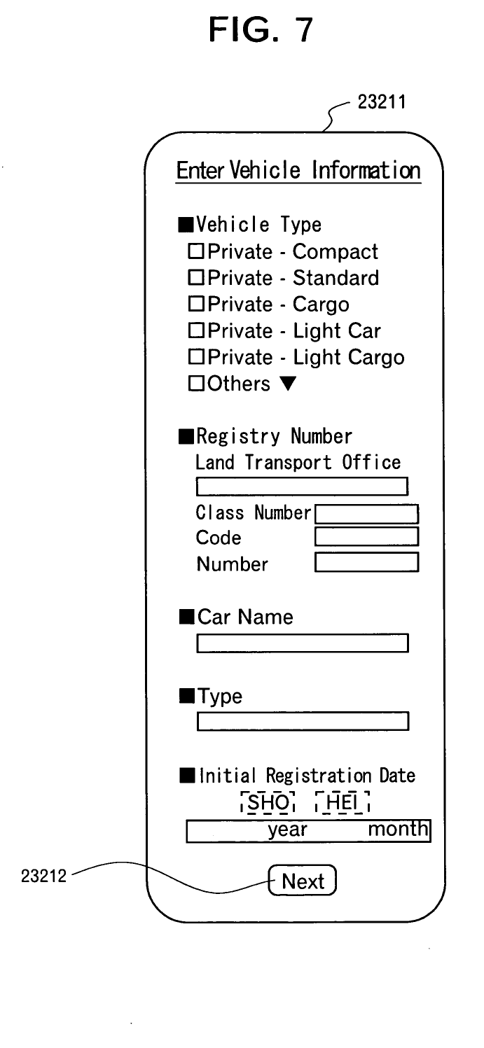

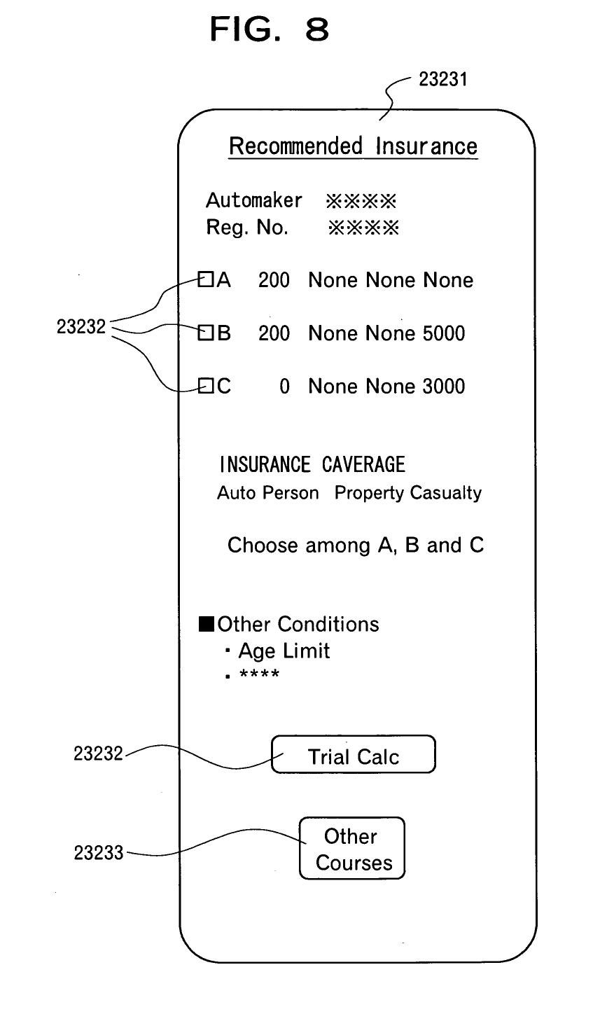

The application data entry form for one selected from various insurance services is given to the terminal unit 3 by using the application assist means 232 in the insurance contract management device 2 in order to make up an application form for new insurance contract of the auto insurance (S110). The application data entry form sent from the insurance contract management device is displayed on the display of the terminal unit 3, so as to allow the sales representative of the insurance agent or the customer to enter the necessary information into the application data entry form displayed on the screen. The application data entered into the terminal unit are submitted to the insurance contract management device 2 in sequence (S111), and then, a new contract application form 2341 is drawn up (S112). As one example of the operation of making up the new contract application form 2341, a vehicle information entry form 23211 is first transmitted from the vehicle information assist means 2321 to the terminal unit 3 to display the form on the display of the terminal unit 3 as shown in FIG. 7. Then, the sales representative or customer enters the vehicle information data into the vehicle information entry form 23211, and thereafter, presses “Next” 23212, simultaneously to submit the entered vehicle information data to the insurance contract management device 2. The vehicle information data submitted to the insurance contract management device 2 are verified with the insurance policy database 2331 to consequently derive a plurality of recommended insurance advice 23232 conformable to the entered vehicle information data and transmit the recommended insurance advice to the terminal unit 3. As shown in FIG. 8, there can be displayed three types of recommended insurance advice as recommended insurance information notice 23231 on the display of the terminal unit 3. If the other information than the recommended insurance advices is desired to be displayed, “Other Contract” 23233 may be selected to change the insurance contract. When pressing “Trial Calculation” 23234 upon selecting one of the recommended insurance courses or changing the insurance contract, the insurance contract management device 2 is required to tentatively calculate the insurance premium.

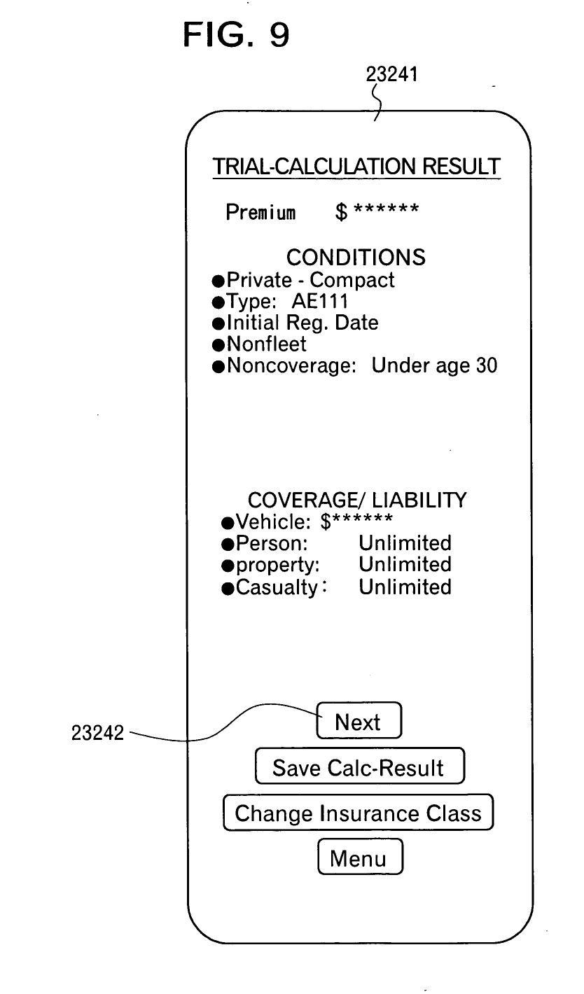

In the insurance contract management device 2, the newly contracted insurance premium or insurance premium of a renewal insurance subjecting to change at the customer's own wish is tentatively calculated in the insurance contract management device 2 in the light of the premium trial-calculation database 2332, so as to transmit the trial-calculation result 23241 from the trial-calculation representation means 2324 to the terminal unit 3. The trial-calculation result 23241 is displayed on the display of the terminal unit 3 as shown in FIG. 9. When the customer accepts the contract suggested by the insurance company, “Next” 23242 in the menu is selected to submit the customer's intention to the insurance contract management device 2. When changing the insurance contract according to the customer's wishes, saving the trial-calculation result, or ceasing the procedure, any relevant item in the menu is selected.

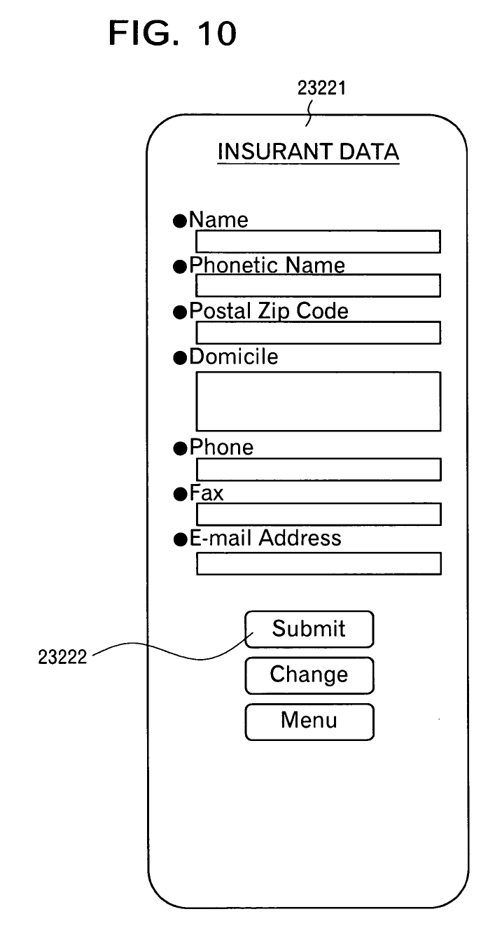

Next, the agent authentication information entry form 23221 is transmitted with the insurant information assist means 2322 of the insurance contract management device 2 and displayed on the display of the terminal unit 3 as shown in FIG. 10, so as to allow the sales representative of the insurance agent or customer to enter the insurant information referring to the agent authentication information entry form 23221. Upon entering the necessary information, “application” 23222 in the menu is selected to submit the insurant information to the insurance contract management device 2. Thus, an application form 2341 is prepared with the application form drafting means on the basis of the entered information data including the vehicle information, insurant information, and contract detail, which are submitted from the terminal unit 3 to the insurance contract management device 2 (S112). The application form 2341 thus prepared is transmitted to the terminal unit 3 by the application form transmission means 251 and displayed on the display of the terminal unit 3 (S113 and S114). The details of the suggested contract policy are confirmed while the sales representative give the explanation of the contract policy to the customer, showing the application form on the display of the terminal unit. Upon completing confirmation of the details of the contract policy, “Confirm Important Matters” 23411 is selected to be transmitted to the insurance contract management device 2. In response thereto, a confirming information entry form 25211 is transmitted from the confirmation assist means 2521 of the contract conclusion means 252 in the insurance contract management device 2 to the terminal unit 3 (S115).

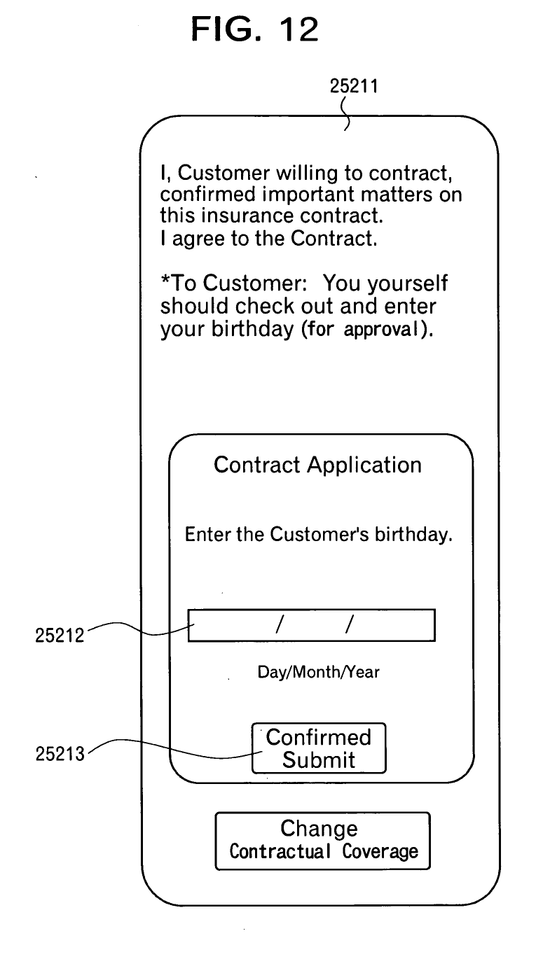

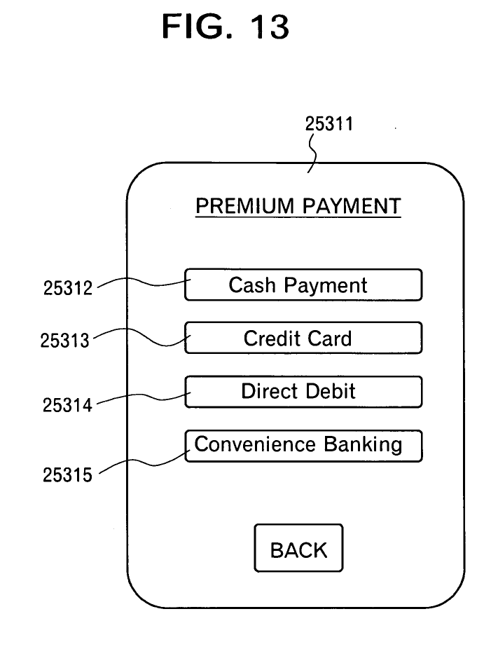

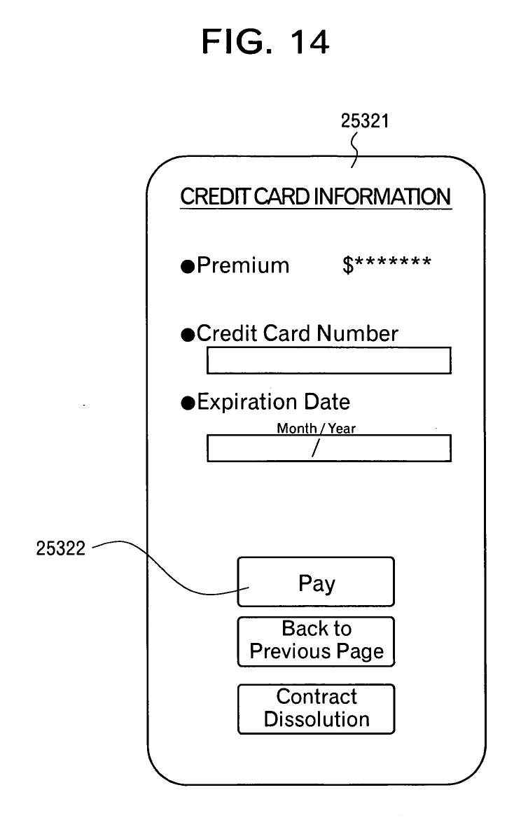

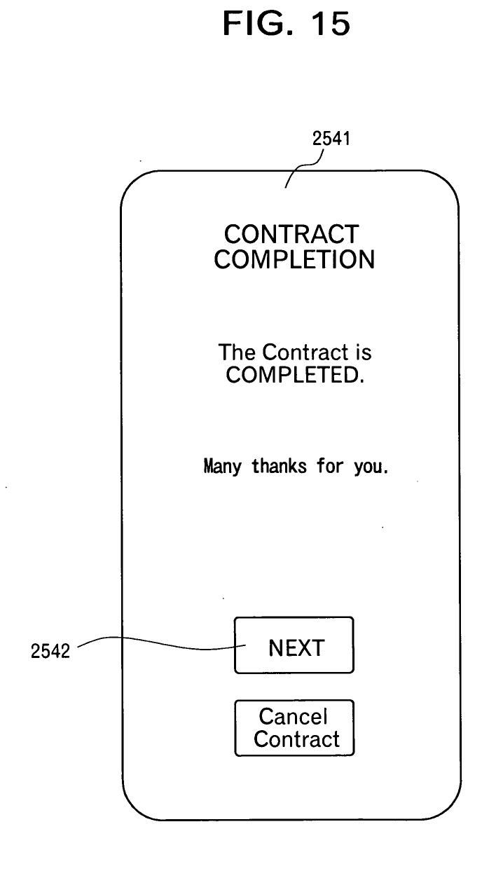

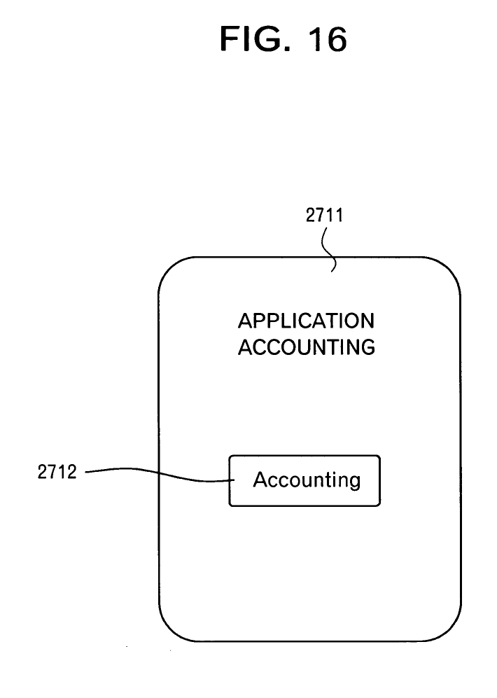

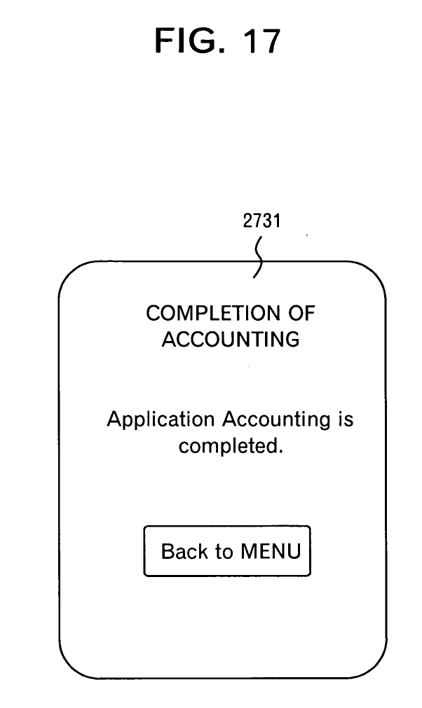

Then, the confirming information entry form 25211 is displayed on the display of the terminal unit 3 as shown in FIG. 12, so as to let the customer enter the customers personal information such as the customer's birthday 25212. Entering of the customer's birthday 25212 implies acceptance of the insurance contract by the customer after being informed of the details of the insurance contract. Then, “Conform/Submit” is selected to be transmitted to the insurance contract management device 2 (S116). Consecutively, the payment means 253 in the insurance contract management device 2 is worked. A payment selection form 25311 as shown in FIG. 13 is transmitted from the payment selection means 2531 to the terminal unit 3 (S117). The customer can select any of “Cash Payment” 25312, “Credit Card” 25313, “Direct Debit” 25314, and “convenience banking” 25315, which the customer prefers on the payment selection form 25311. If the customer selects “Credit Card” 25313 to submit the customer's selection to the insurance contract management device 2 (S118), a payment information entry form 25321 is transmitted from the payment information assist means of the insurance contract management device to the terminal unit (S119), to display the form on the display of the terminal unit 3 as shown in FIG. 14. The form on the display of the terminal unit facilitates customer's entering of the credit card information such as credit card number and card expiration date. Upon entering the credit card information, “Payment” 25322 is selected and notified to the insurance contract management device 2 (S120), simultaneously to notify the credit card payment information of the customer to the payment information reception means 2533. In this manner, the contract procedure is completed, thus to transmit a contract completion notice 2541 from the contract completion notification means 254 of the insurance contract management device 2 and displayed on the display of the terminal unit 3 as shown in FIG. 15 (S122). Seeing the notice on the display, the sales representative and the customer can be made aware of conclusion of the insurance contract. Then, by selecting “Next” 2542 in the contract completion notice 2541 on the display, an accounting instruction form 2711 is transmitted from the accounting instruction form 271 of the insurance contract management device 2 to the terminal unit (S123), and displayed on the display of the terminal unit as shown in FIG. 16. When the sales representative selects “Accounting” 2712 on the display, it is notified to the insurance contract management device 2 (S124), the contents of the application form 2341 are accounted for by the host computer 5 of the insurance company through the insurance accounting means 272 (S125). This electronic accounting system prevents erroneous procedures such as reading mistake, which often occurred heretofore and eliminates the need for preparing OCR data of the insurance contract information. Besides, no specific operation is needed for transmitting the information data, and preparation of the application form can easily be performed only by giving an accounting command at the end of the procedures for preparing the application form without imposing any burden on the insurance agent and the insurance company (including the branch offices thereof). Upon completion of the accounting procedure involving in proceeding with the insurance contract, a completed accounting notification 2731 as shown in FIG. 17 is transmitted from the completed accounting notification means 273 to the terminal unit 3 (S126 and S127). Seeing the notification on the display, the sales representative of the insurance agent can make sure completion of the accounting. Upon accounting the insurance contract, a written contract confirmation to be submitted to the customer or insurant is made up with the confirmation drawing means 274 of the insurance contract management device 2 (S128). The written contract confirmation is formally printed out and forwarded to the customer by postal mail after 3 business days of conclusion of the insurance contract. The forwarding by mail of the written contract confirmation to the customer prevents a fraudulent contract placed without customer's knowledge or other irregularities in a contract, thus to ensure appropriate procedures for making an insurance contract. After concluding the insurance contract the customer desires, there may be employed a follow-up service system for allowing the customer or insurant to confirm the conditions of the insurance contract by telephone or through a network as quick as a call center of the insurance company receives inquiry from the customer or insurant. This follow-up system can dispel anxieties about insurance operation.

### WORKING EXAMPLE 2

The working example 2 for carrying forward the procedures for a continuing insurance contract with the insurance contract management device 2 getting both the terminal authentication information and the agent authentication information will be described here. The same operation as in the new insurance contract described above will be omitted.

Conventionally, an application form for continuing insurance contract was heretofore forwarded by postal mail to the customer or insurant having the insurance policy close to the expiration, thus causing the drop of the percentage of contract conclusion. Consequently, an insurance solicitor of the insurance company or insurance agent often canvasses for renewal insurance. The solicitor visiting the insurant having the insurance policy close to the expiration first connects his/her terminal unit 3 to the insurance contract management device 2 of the insurance company through the network 4 by using the dedicated adapter plugged into the terminal unit, thereby to transmit the terminal authentication information to the insurance contract management device 2 (S101 and S102). The solicitor or sales representative of the insurance agent enters the agent authentication information into the agent authentication information form on the display of the terminal unit 3 in accordance with the agent authentication information entry form given from the insurance contract management device 2. Upon filling in the form, the information entered into the form is submitted to the insurance contract management device 2, consequently to forward the menu 2311 from the service information means 231 of the insurance contract management device to the terminal unit upon authenticating the terminal authentication information and agent authentication information with the authentication means 214 of the insurance contract management device 2 (S103 through S108). Then, “Auto Insurance (renewal)” 23121 on the menu shown in FIG. 6 is selected and notified to the insurance contract management device 2 (S109).

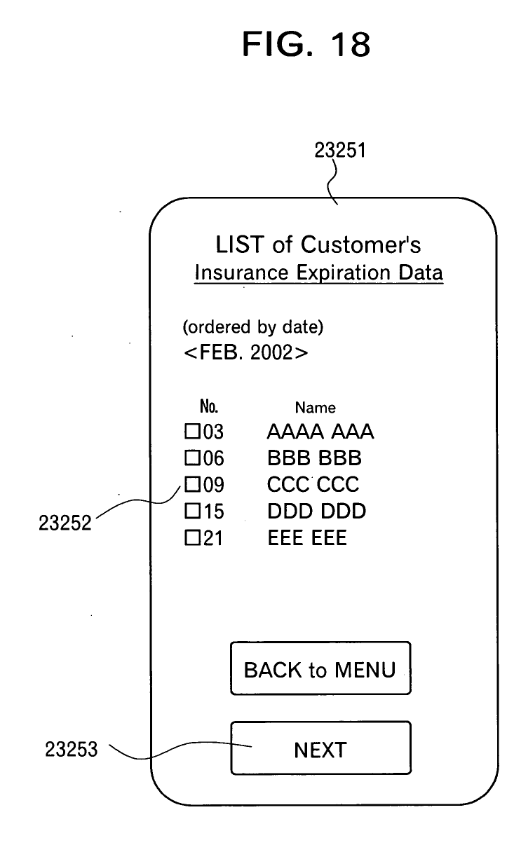

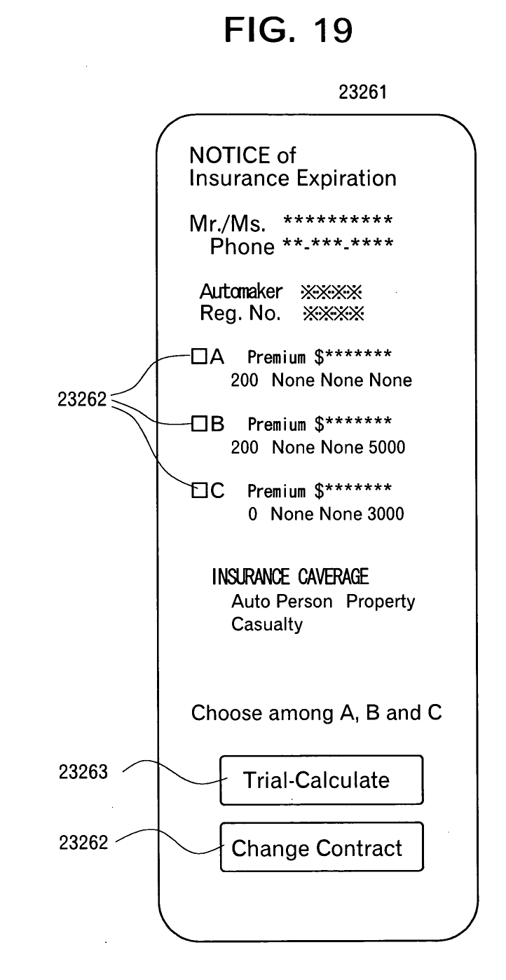

Subsequently, various application data entry forms for preparing an application form for renewal contract of auto insurance are transmitted from the application assist means 232 to the terminal unit 3 (S110). The relevant application data entry form is displayed on the display of the terminal unit to permit the sales representative or customer to enter the required information into the form in sequence, to submit the entered information to the insurance contract management device 2 (S111) and to make up the required renewal contract application form 2341 (S112). The renewal contract application form by way of example may be prepared by searching the expiration information database 2333 on the basis of the agent authentication information and transmitting a list of expiration information of the customer in the charge of the sales representative of the insurance agent to the terminal unit 3. The list of expiration information on the display of the terminal unit 3 contains the names of the customers each having the insurance policy close to the expiration as shown in FIG. 18. The sales representative searches within the list of expiration information 23251 to retrieve the target name of the customer now in the charge of the sales representative, and then, selects “Next” 23253, so that the notice of insurance expiration information 23261, which was already sent to the customer, is displayed on the display of the terminal unit 3. On the display of the terminal unit 3, three types of recommended insurance advice for renewal contract are displayed as shown in FIG. 19. When selecting “Modified Contract” 23263 on the display, other contract information is displayed instead of the contract information 23262. By selecting one of three types of the contract information upon changing the contract type and pressing “Trial-calculation” 23264, a command for trial calculation of insurance premium is submitted to the insurance contract management device 2.

In the insurance contract management device 2, the insurance premium for the newly contracted or renewal insurance is provisionally calculated referring to the premium trial-calculation database 2332, and then, the calculating result 23241 of the insurance premium is transmitted from the trial-calculation representation means 2324 to the terminal unit 3. Thus, the calculating result 23241 is displayed on the display of the terminal unit 3 as shown in FIG. 9. When the customer consents the contract conditions including the estimated insurance premium on the display of the terminal unit, “Next” 23242 is selected to notify the customer's consents to the insurance contract management device 2. In a case of requesting to change the contract conditions, save the trial calculating result or suspend the procedures, the requested form can be arbitrarily displayed.

Next, the insurant information of the insurant registered beforehand in the insurant database 2334 is retrieved from the database with the insurant information transmission means 2327 of the insurance contract management device 2. Upon confirming the insurant information thus retrieved and displayed on the display of the terminal unit as shown in FIG. 20, “Apply” 23272 is selected to be transmitted to the insurance contract management device 2. Then, an application form 2341 is made up with the application form drafting means 234 of the insurance contract management device 2 on the basis of the contract policy selected at the terminal unit 3 and the confirmed insurant information (S112). The subsequent procedures are the same as in that for the new insurance contract as described above (S113 through S128).

Thus, according to the insurance contract accounting system 1 of the invention, while carrying forward the procedures for insurance contract in face-to-face consultation between the sales representative of the insurance agent and the customer, the given terminal unit 3 is connected to the insurance contract management device 2 through the network, so that the application form for insurance contract can easily be made up with reference to the application data entry forms sent from the insurance contract management device 2. While presenting the application form 2341 on the display of the terminal unit 3 to the customer, the sales representative of the insurance agent gives an account of the insurance policy and other important information to the customer, and then, the customer upon accepting the insurance policy enters the customer's personal data as a substitute for signature or seal in acknowledgement of the insurance policy, consequently to conclude the insurance contract. Merely by proceeding with the accounting procedure for the insurance contract subsequent to making of the application form, the information data filled in the application form are accounted for the insurance company to complete the contract accounting. Thus, tangled service procedures for arranging the insurance contract and preparing various documents, which impose excessive burdens on the insurance company (including the business branch offices thereof), can be cut through effectively according to the invention. Although the conventional procedures for arranging the insurance contract using a terminal device for exclusive use for arranging the insurance contract necessitate a specialized computer insurance service program and replacement of the computer program in accordance with addition of insurance company's lines of business or revision of insurance rate, the insurance contract accounting system of the invention, which can use any type of computer as the terminal unit 3, can save the trouble of replacing the insurance service program in the system of the insurance agent. Consequently, the insurance agent can actively do insurance business for selling insurance, efficiently using time, which was required for replacing the insurance service program in the past. Besides, the insurance agent, who treats the insurance service business as a side business, can attend to the duties of the real business thereof.

Furthermore, the insurance contract can be concluded using the terminal unit connected to the insurance contract management device 2 through a network without need of printing out a variety of application forms, consequently to significantly lower costs of printing, storing and distributing conventionally required application forms.

### WORKING EXAMPLE 3

There will be described a working example 3 for browsing the insurance related information without submitting the terminal authentication information to the insurance contract management device. In the diagrams of this embodiment, like components are denoted by the like numerical symbols.

In a case where the sales representative of the insurance agent, who does not carry a terminal unit, handheld mobile terminal (personal digital assistant; PDA) and/or dedicated adapter, gives an informed account to a customer outside the business office of the insurance agent, a computer possessed by the customer or available at an Internet cafe may be used as the terminal unit 3 available temporarily and connected to the insurance contract management device 2 (S301). In this case, the terminal authentication information is not submitted from the temporary terminal unit 3 to the insurance contract management device 2, but an agent authentication information entry form is transmitted from the insurance contract management device 2 to the temporary terminal unit 3 (S103), to display an data entry form on the display of the terminal unit for entering agent-specific ID code and password previously given to the insurance agent or the sales representative of the insurance agent. Upon entering the agent-specific ID code and password into the terminal unit, these agent-specific data are submitted to the insurance contract management device 2 (S104) and sent to the agent authentication information acquisition means 213 (S105). The agent-specific data is authenticated by the authentication means 214 of the insurance contract management device 2 (S106) and determined on authentication level with the level determination means 2142 (S107). Since the insurance contract management device receives only the agent authentication information, but does not receive the terminal authentication information in this case, the authentication level is determined as “Level 2”, thus to transmit the corresponding menu 2311 from the service information means 231 to the terminal unit (S108). The menu 2311 on the display of the terminal unit 3 is shown in FIG. 6, but unavailable services are distinguished with different color. That is, on the menu, only the items “Trial Calculation” 23131, “Phone Directory” 23141, and “Contract Enquiry” 23142 can be selected. Upon selecting any of these available items (S109), the application assist means 232 is operated for permitting access to insurance-related information (S305), thereby to retrieve and disclose the corresponding available service from the insurance-related database 233 and display an entry form necessary for disclosing the information (S306). If the item “Trial Calculation” 23131 is selected as an example, a vehicle information entry form 23211 as shown in FIG. 7 is transmitted to the terminal unit 3, and then, upon entering the necessary data into the terminal unit 3 and selecting “Next” 23212, the entered vehicle information is submitted to the insurance contract management device 2. In response thereto, some recommended insurance advices 23232 appropriate to the vehicle information obtained by making reference to the insurance policy database 2331 are given to the terminal unit 3 as a recommended insurance information notice 23231. In the case illustrated in FIG. 8, three types of recommended insurance advices 23232 are displayed as the recommended insurance information notice 23231 as the customer chooses. In a case where the customer wishes to select the other insurance than those indicated as the recommended insurance advices 23232, “Other Contract” 23233 may be selected to change the insurance contract. After selecting any of three types of insurance contracts or changing the insurance contract, “Trial-calculation” 23264 is selected to demand trial calculation of the insurance contract management device 2, in response to which the insurance contract management device 2 makes a trial calculation of the insurance contract the customer wishes, referring to the premium trial-calculation database 2332. Consequently, the trial-calculation result 23241 thus obtained is transmitted from the trial-calculation representation means 2324 to the terminal unit 3 and displayed on the display of the terminal unit 3 as shown in FIG. 9. Although “Next” 23242 was selected in the working example 1, “Next” 23242 cannot be selected because of the contracting procedure of low authentication level in this working example 3, resulting in closing access to the insurance-related service. But, it is possible to save the image of the trial-calculation result 23241 or continuously browse other insurance service information.

As just described, the insurance contract cannot be concluded when submitting the terminal authentication information to the insurance contract management device, but the sales representative may use any type of computer at hand as the terminal unit to offer consultation of various type of insurance services with the customer. Thus, the insurance representatives can improve the opportunity of soliciting the customer to insure. By making use of both the agent authentication information and terminal authentication information, the insurance company can rigorously authenticate not only the customers or users but also the terminal unit 3 in itself. Since the insurance contract accounting system of the invention can offer various insurance services and information disclosures depending on person or insurance service representatives dealing with the insurance contract or customer, insurant or user, who use the terminal unit 3 (any kind of terminal) to be connected to the insurance contract management device of the insurance company, even a system capable of easily accessing to the host computer of the insurance company to obtain various important information on insurance contracts can ensure the security of the significant insurance contract data.

### INDUSTRIAL APPLICABILITY

As is disclosed above, in the insurance contract accounting system of the present invention, since only the insurance agent having an agent authentication information assigned by the insurance company is authorized beforehand to make up an insurance application form, an application for insurance contract is necessarily managed by the authenticated insurance agent unlike in the conventional insurance sales system using the Internet. Thus, the procedures for offering face-to-face consultation of insurance contract with the customer can be carried out efficiently free from troublesome paper work of handling a number of contract documents, which were needed in the past, while taking advantage of the conventional face-to-face sales of insurance. Besides, the system of the invention can eliminate the need for preparing, storing and handling the documents necessary for various types of insurance contracts, consequently to drastically reduce the costs for preparing and storing the necessary documents.

The system of the invention further has an outstanding advantage capable of definitely identifying the customer or insurant willing to insure through a network by using the customer's specific information such as date of the insurant's birth as authentication information, as a result of which the same security of customer identification as in the customary way can be ensured.

Furthermore, since the written contract policy printed upon conclusion of the insurance contract is forwarded to the customer or insurant by postal mail according to the system of the invention, a fraudulent contract placed without customer's knowledge or other irregularities in a contract can be prevented, thus to ensure the safety of insurance contract.

Besides, since the system of the invention uses not only the agent authentication information but also the terminal authentication information, the user and terminal unit attempting to be connected to the insurance contract management device are authenticated, thus to increase the safety of information disclosed by the insurance contract management device of the invention.

1. An insurance contract accounting system comprising an insurance contract management device connected to a terminal unit of an insurance agent through a network, said management device including an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of confirmation data indicative of completion of confirming said insurance application sent from said terminal unit, and contract accounting means for accounting the insurance contract stipulated on said application form thus completed when completion of the insurance contract.

2. An insurance contract accounting system comprising an insurance contract management device connected to a terminal unit of an insurance agent through a network, said management device including an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of confirmation data indicative of completion of confirming said insurance application sent from said terminal unit, and contract accounting means for accounting the insurance contract stipulated on said application form thus completed in accordance with accounting instructions from said terminal unit indicative of completion of the insurance contract.

3. An insurance contract accounting system comprising an insurance contract management device connected to a terminal unit of an insurance agent through a network, said management device including an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of insurant-specific confirmation data indicative of completion of confirming said insurance application sent from said terminal unit, and contract accounting means for accounting the insurance contract stipulated on said application form thus completed when completion of the insurance contract.

4. An insurance contract accounting system comprising an insurance contract management device connected to a terminal unit of an insurance agent through a network, said management device including an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of insurant-specific confirmation data indicative of completion of confirming said insurance application sent from said terminal unit, and contract accounting means for accounting the insurance contract stipulated on said application form thus completed in accordance with accounting instructions from said terminal unit indicative of completion of the insurance contract.

5. An insurance contract accounting system comprising an insurance contract management device connected to a terminal unit of an insurance agent through a network, said management device including an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of confirmation data indicative of completion of confirming said insurance application sent from said terminal unit, contract accounting means for accounting the insurance contract stipulated on said application form thus completed when completion of the insurance contract, and confirmation drawing means for drawing a contract confirmation document containing confirmation matters indicative of conclusion of the insurance contract for an insurant.

6. An insurance contract accounting system comprising an insurance contract management device connected to a terminal unit of an insurance agent through a network, said management device including an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of confirmation data indicative of completion of confirming said insurance application sent from said terminal unit, contract accounting means for accounting the insurance contract stipulated on said application form thus completed in accordance with accounting instructions from said terminal unit indicative of completion of the insurance contract, and confirmation drawing means for drawing a contract confirmation document containing confirmation matters indicative of conclusion of the insurance contract for an insurant.

7. An insurance contract accounting system comprising an insurance contract management device connected to a terminal unit of an insurance agent through a network, said management device including an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of insurant-specific confirmation data indicative of completion of confirming said insurance application sent from said terminal unit, contract accounting means for accounting the insurance contract stipulated on said application form thus completed when completion of the insurance contract, and confirmation drawing means for drawing a contract confirmation document containing confirmation matters indicative of conclusion of the insurance contract for an insurant.

8. An insurance contract accounting system comprising an insurance contract management device connected to a terminal unit of an insurance agent through a network, said management device including an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of insurant-specific confirmation data indicative of completion of confirming said insurance application sent from said terminal unit, contract accounting means for accounting the insurance contract stipulated on said application form thus completed in accordance with accounting instructions from said terminal unit indicative of completion of the insurance contract, and confirmation drawing means for drawing a contract confirmation document containing confirmation matters indicative of conclusion of the insurance contract for an insurant.

9. An insurance contract accounting system comprising an insurance contract management device connected to a terminal unit of an insurance agent through a network, said management device including a terminal authentication information acquisition means for getting terminal authentication information for identifying said terminal unit, an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of confirmation data indicative of completion of confirming said insurance application sent from said terminal unit, and contract accounting means for accounting the insurance contract stipulated on said application form thus completed when completion of the insurance contract.

10. An insurance contract accounting system comprising an insurance contract management device connected to a terminal unit of an insurance agent through a network, said management device including a terminal authentication information acquisition means for getting terminal authentication information for identifying said terminal unit, an agent authentication assist means for transmitting an agent authentication information entry form for letting said agent enter agent authentication information data assigned to said agent by said insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of confirmation data indicative of completion of confirming said insurance application sent from said terminal unit, and contract accounting means for accounting the insurance contract stipulated on said application form thus completed in accordance with accounting instructions from said terminal unit indicative of completion of the insurance contract.

11. An insurance contract accounting system comprising an insurance contract management device connected to a terminal unit of an insurance agent through a network, said management device including a terminal authentication information acquisition means for getting terminal authentication information for identifying said terminal unit, an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of insurant-specific confirmation data indicative of completion of confirming said insurance application sent from said terminal unit, and contract accounting means for accounting the insurance contract stipulated on said application form thus completed when completion of the insurance contract.

12. An insurance contract accounting system comprising an insurance contract management device connected to a terminal unit of an insurance agent through a network, said management device including a terminal authentication information acquisition means for getting terminal authentication information for identifying said terminal unit, an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of insurant-specific confirmation data indicative of completion of confirming said insurance application sent from said terminal unit, and contract accounting means for accounting the insurance contract stipulated on said application form thus completed in accordance with accounting instructions from said terminal unit indicative of completion of the insurance contract.

13. An insurance contract accounting system comprising an insurance contract management device connected to a terminal unit of an insurance agent through a network, said management device including a terminal authentication information acquisition means for getting terminal authentication information for identifying said terminal unit, an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of confirmation data indicative of completion of confirming said insurance application sent from said terminal unit, contract accounting means for accounting the insurance contract stipulated on said application form thus completed when completion of the insurance contract, and confirmation drawing means for drawing a contract confirmation document containing confirmation matters indicative of conclusion of the insurance contract for an insurant.

14. An insurance contract accounting system comprising an insurance contract management device connected to a terminal unit of an insurance agent through a network, said management device including a terminal authentication information acquisition means for getting terminal authentication information for identifying said terminal unit, an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of confirmation data indicative of completion of confirming said insurance application sent from said terminal unit, contract accounting means for accounting the insurance contract stipulated on said application form thus completed in accordance with accounting instructions from said terminal unit indicative of completion of the insurance contract, and confirmation drawing means for drawing a contract confirmation document containing confirmation matters indicative of conclusion of the insurance contract for an insurant.

15. An insurance contract accounting system comprising an insurance contract management device connected to a terminal unit of an insurance agent through a network, said management device including a terminal authentication information acquisition means for getting terminal authentication information for identifying said terminal unit, an agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of insurant-specific confirmation data indicative of completion of confirming said insurance application sent from said terminal unit, contract accounting means for accounting the insurance contract stipulated on said application form thus completed when completion of the insurance contract, and confirmation drawing means for drawing a contract confirmation document containing confirmation matters indicative of conclusion of the insurance contract for an insurant.

16. An insurance contract accounting system comprising an insurance contract management device connected to a terminal unit of an insurance agent through a network, said management device including a terminal authentication information acquisition means for getting terminal authentication information for identifying said terminal unit, an 5 agent authentication assist means for transmitting an agent authentication information entry form for letting said agent enter agent authentication information data assigned to said agent by an insurance company, an authentication means for authenticating said information data submitted from said terminal unit of said agent, an application assist means for transmitting an application data entry form for letting said agent enter 10 application data for an insurance contract and insurance related information data to said terminal unit having information data authenticated, application form drafting means for drawing up an insurance application form on the basis of said application data sent from said terminal unit, application form transmission means for transmitting said application form thus drawn to the terminal unit to display said application form on a display of said terminal unit, a contract conclusion means for concluding the insurance contract upon reception of insurant-specific confirmation data indicative of completion of confirming said insurance application sent from said terminal unit, contract accounting means for accounting the insurance contract stipulated on said application form thus completed in accordance with accounting instructions from said terminal unit indicative of completion of the insurance contract, and confirmation drawing means for drawing a contract confirmation document containing confirmation matters indicative of conclusion of the insurance contract for an insurant.

17. The insurance contract accounting system set forth in claim 9, wherein said authentication means determines an authentication level based on a combination of said agent authentication information and said terminal authentication information.

18. The insurance contract accounting system set forth in claim 17, further comprising a service information means for allowing service information provided from said insurance contract management device to said terminal unit, so as to provide insurance services in accordance with said authentication level determined by said authentication means.

19. The insurance contract accounting system set forth in claim 18, wherein contract-related insurance service of said insurance services provided is available to said terminal unit when said authentication means authenticates said agent authentication information and said terminal authentication information.

20. The insurance contract accounting system set forth in claim 18, wherein contract-related insurance service of said insurance services provided is available to said terminal unit when said authentication means authenticates said agent authentication information.

21. The insurance contract accounting system set forth in claim 10, wherein said authentication means determines an authentication level based on a combination of said agent authentication information and said terminal authentication information.

22. The insurance contract accounting system set forth in claim 11, wherein said authentication means determines an authentication level based on a combination of said agent authentication information and said terminal authentication information.

23. The insurance contract accounting system set forth in claim 12, wherein said authentication means determines an authentication level based on a combination of said agent authentication information and said terminal authentication information.

24. The insurance contract accounting system set forth in claim 13, wherein said authentication means determines an authentication level based on a combination of said agent authentication information and said terminal authentication information.

25. The insurance contract accounting system set forth in claim 14, wherein said authentication means determines an authentication level based on a combination of said agent authentication information and said terminal authentication information.

26. The insurance contract accounting system set forth in claim 15, wherein said authentication means determines an authentication level based on a combination of said agent authentication information and said terminal authentication information.

27. The insurance contract accounting system set forth in claim 16, wherein said authentication means determines an authentication level based on a combination of said agent authentication information and said terminal authentication information.
